(19) United States
(12) Patent Application Publication
(10) Pub. No.: US 2026/0272025 A1
(43) Pub. Date: Sep. 17, 2026

(54) AEROSOL GENERATOR

(71) Applicant: Nicoventures Trading Limited, London (GB)

(72) Inventors: Mark POTTER, London (GB); Mark LEGG, London (GB)

(21) Appl. No.: 19/469,145

(22) PCT Filed: Mar. 28, 2024
(86) PCT No.: PCT/EP2024/058590

§ 371 Date: Sep. 25, 2025

(30) Foreign Application Priority Data
Mar. 29, 2023 (GB) 2304653.5
Sep. 12, 2023 (GB) 2313902.5

(51) Int. Cl. A24F 40/46; A24F 40/57; H05B 1/02; H05B 3/03

(52) U.S. Cl. CPC A24F 40/46; A24F 40/57; H05B 1/0252; H05B 3/03

(57) ABSTRACT

The application relates to an aerosol generator of an article for an aerosol provision device. The aerosol generator has aerosol generating material; and a resistive heating layer comprising a resistive heating element. The resistive heating element is configured to heat at least a portion of the aerosol generating material, the aerosol generating material being on the resistive heating layer. The resistive heating element comprises an electrical contact of a first type and an electrical contact of a second type, and the resistive heating element extends between the electrical contact of the first type and the electrical contact of the second type. The resistive heating element has a breakdown voltage, such that the resistive heating element is rendered inoperable in response to a control signal in excess of the breakdown voltage.

### CROSS-REFERENCE TO RELATED APPLICATIONS

This present application is a National Phase entry of PCT Application No. PCT/EP2024/058590, filed 28 Mar. 2024, which claims priority from Great Britain Application No. 2313902.5, filed 12 Sep. 2023, and which claims priority from Great Britain Application No. 2304653.5, filed 29 Mar. 2023, each of which are fully incorporated herein by reference in their entireties.

### TECHNICAL FIELD

The present specification relates to an aerosol generator of an article for an aerosol provision device. The present specification also relates to an electrically resistive heating device, such as an aerosol generator or a consumable part of an aerosol generating device. The present specification further relates to an article for an aerosol provision device, an aerosol provision device, an aerosol provision system, a method of forming an aerosol generator of an article for an aerosol provision device, and a blank for forming an aerosol generator of an article for an aerosol provision device.

### BACKGROUND

Aerosol generators for use in aerosol generating devices, such as an e-cigarettes, have been developed for releasing compounds without requiring combustion. Some example aerosol generating devices including resistive heater for use in generating an aerosol. There remains a need for further developments in such devices.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to an aspect, there is provided an aerosol generator of an article for an aerosol provision device, the aerosol generator comprising: aerosol generating material; and a resistive heating layer comprising a resistive heating element, the resistive heating element being configured to heat at least a portion of the aerosol generating material, the aerosol generating material being on the resistive heating layer; wherein the resistive heating element comprises an electrical contact of a first type and an electrical contact of a second type, and the resistive heating element extends between the electrical contact of the first type and the electrical contact of the second type; and wherein the resistive heating element has a breakdown voltage, such that the resistive heating element is rendered inoperable in response to a control signal in excess of the breakdown voltage.

In an embodiment of any of the above, the resistive heating element is one of a plurality of resistive heating elements of the resistive heating layer.

In an embodiment of any of the above, each of the resistive heating elements has a breakdown voltage, such that the respective heating element is rendered inoperable in response to a control signal in excess of the breakdown voltage.

In an embodiment of any of the above, each resistive heating element is configured to heat a respective portion of the aerosol generating material.

In an embodiment of any of the above, the electrical contacts enable the electric current to be individually provided to each of the plurality of resistive heating elements.

In an embodiment of any of the above, comprising a plurality of electrical contacts of the first type.

In an embodiment of any of the above, wherein each of the resistive heating elements has a separate electrical contact of the first type.

In an embodiment of any of the above, wherein the electrical contacts comprise a single contact of a second type.

In an embodiment of any of the above, wherein electrical contacts of the first and second type are arranged on opposite sides of the resistive heating layer.

In an embodiment of any of the above, wherein electrical contacts of the first and second type are arranged on the same side of the resistive heating layer.

In an embodiment of any of the above, the aerosol generator comprises an aerosol generating layer including the aerosol generating material. In an embodiment of any of the above, the aerosol generating layer is on the resistive heating layer.

In an embodiment of any of the above, comprising an input for receiving the control signal.

In an embodiment of any of the above, wherein, in use, the control signal is configured to be generated following usage of the heating element.

In an embodiment of any of the above, wherein the heating element comprises a non-linear electrically conducting path between the contact of the first type and the contact of the second type.

In an embodiment of any of the above, wherein the resistive heating element comprises a fuse portion which has a breakdown voltage.

In an embodiment of any of the above, wherein the fuse portion has a breakdown portion lower than a breakdown voltage of a remainder of the resistive heating element.

In an embodiment of any of the above, wherein the fuse portion comprises a region of a reduced dimension.

In an embodiment of any of the above, wherein the reduced dimension comprises at least one of thickness and width compared with an adjacent region.

In an embodiment of any of the above, wherein the reduced dimension comprises a portion of reduced cross sectional area compared with an adjacent region.

In an embodiment of any of the above, wherein the fuse portion comprises a surface feature.

In an embodiment of any of the above, wherein the surface feature comprises at least one of a perforation, indent and neck.

In an embodiment of any of the above, electrical contacts of the first type are arranged on a first side of an area of the resistive heating layer in which the heating elements are provided and the electrical contacts of the second type are arranged on a second side of an area of the resistive heating layer in which the heating elements are provided.

In an embodiment of any of the above, electrical contacts of the first type are arranged on a first edge of the resistive heating layer and the electrical contacts of the second type are arranged on a second edge of the resistive heating layer.

In an embodiment of any of the above, the aerosol generator defines a longitudinal axis. In an embodiment of any of the above, the first side extends in the longitudinal direction. In an embodiment of any of the above, the second side extends in the longitudinal direction.

In an embodiment of any of the above, the electrical contacts of the first type and the electrical contacts of the second type are arranged on a single side of an area of the resistive heating layer in which the heating elements are provided.

In an embodiment of any of the above, the electrical contacts of the first type and the electrical contacts of the second type are arranged on a single edge of the resistive heating layer. In an embodiment of any of the above, the aerosol generator is elongate. In an embodiment of any of the above, the single side is a longitudinal end. In an embodiment of any of the above, the single side is a longitudinally extending side.

In an embodiment of any of the above, the electrical contact of the first type is configured to electrically connect with a device electrical connector. In an embodiment of any of the above, the electrical contact of the first type comprises an exposed contact area.

In an embodiment of any of the above, the electrical contact of the second type is configured to electrically connect with a device electrical connector. In an embodiment of any of the above, the electrical contact of the second type comprises an exposed contact area.

In an embodiment of any of the above, the resistive heating layer forms an array of heating elements comprising at least a first heating element and a second heating element. In an embodiment of any of the above, the plurality of resistive heating elements comprise an array of heating elements arranged in a row.

In an embodiment of any of the above, the plurality of heating elements comprises a single row of resistive heating elements. In an embodiment of any of the above, the array of heating elements are arranged in a row parallel to a longitudinal axis.

In an embodiment of any of the above, the array of heating elements are arranged in a row perpendicular to a longitudinal axis.

In an embodiment of any of the above, the aerosol generator may comprise a first surface and a second surface different to the first surface; wherein the aerosol generating material is exposed at the first surface; and wherein at least one of the first type of electrical contact and the second type of electrical contact is exposed at the second surface. In an embodiment of any of the above, the aerosol generator may comprise a first surface and a second surface different to the first surface; wherein the aerosol generating layer is exposed at the first surface; and wherein at least one of the first type of electrical contact and the second type of electrical contact is exposed at the second surface.

In an embodiment of any of the above, the resistive heating layer comprises a fold. In an embodiment of any of the above, the resistive heating element is on a resistive heating element portion of the resistive heating layer defined by the fold.

In an embodiment of any of the above, at least one of the first type of electrical contact and the second type of electrical contact on an electrical contact portion of the resistive heating layer is defined by the fold.

In an embodiment of any of the above, the aerosol generator may comprise a support. In an embodiment of any of the above, the support is configured to support the resistive heating layer. In an embodiment of any of the above, the support comprises a support layer.

In an embodiment of any of the above, the support layer is configured to support the first type of electrical contact and the second type of electrical contact.

In an embodiment of any of the above, the support layer is electrically insulative. In an embodiment of any of the above, comprises at least one of paper and card. In an embodiment of any of the above, the resistive heating layer is in the form of a foil.

In an embodiment of any of the above, the aerosol generating material is in direct contact with the resistive heating layer. In an embodiment of any of the above, the aerosol generating material is in indirect contact with the resistive heating layer. In an embodiment of any of the above, the resistive heating layer is sandwiched between the support layer and the aerosol generating material.

In an embodiment of any of the above, the aerosol generating layer is in direct contact with the resistive heating layer. In an embodiment of any of the above, the aerosol generating layer is in indirect contact with the resistive heating layer. In an embodiment of any of the above, the resistive heating layer is sandwiched between the support layer and the aerosol generating layer.

In an embodiment of any of the above, the resistive heating layer and the support layer define a substrate. In an embodiment of any of the above, the aerosol generator comprises a laminate comprising the resistive heating layer and the support layer. In an embodiment of any of the above, the laminate comprises the aerosol generating layer. In an embodiment of any of the above, the area of the support layer corresponds to the area of the resistive heating layer.

In an embodiment of any of the above, the resistive heating element is formed by at least one of: cutting the resistive heating layer; chemically etching the resistive heating layer; forming or pressing the resistive heating layer in the substrate; and printing the resistive heating layer.

In an embodiment of any of the above, the first type of electrical contact is configured to electrically connect with a device electrical connector and the second type of electrical contact is configured to electrically connect with the device electrical connector.

In an embodiment of any of the above, the support layer defines an exposed contact area of the first type of electrical contact.

In an embodiment of any of the above, wherein the exposed contact area is a first exposed contact area, and the support defines a second exposed contact area of the second type of electrical contact.

In an embodiment of any of the above, the aerosol generating layer is a continuous aerosol generating layer.

In an embodiment of any of the above, the aerosol generating layer is a discontinuous aerosol generating layer.

In an embodiment of any of the above, the aerosol generating layer comprises a plurality of discrete aerosol generating portions.

In an embodiment of any of the above, the resistive heating element is one of a plurality of resistive heating elements.

In an embodiment of any of the above, one of the discrete aerosol generating portions is associated with a corresponding one of the plurality of resistive heating elements.

In an embodiment of any of the above, the aerosol generating layer comprises at least one of dots, strips and patches.

In an embodiment of any of the above, the aerosol generating layer comprises a film or gel layer comprising the aerosol generating material.

In an embodiment of any of the above, the resistive heating layer is in the form of a foil. In an embodiment of any of the above, the resistive heating layer comprises a metal layer.

In an embodiment of any of the above, each resistive heating element is at least a portion of an electrically conductive path between the first type of electrical contact and the second type of electrical contact.

In an embodiment of any of the above, the at least a portion of an electrically conductive path between the first type of electrical contact and the second type of electrical contact is a non-linear path. In an embodiment of any of the above, the at least a portion of an electrically conductive path between the first type of electrical contact and the second type of electrical contact is a meandering path. In an embodiment of any of the above, each resistive heating element is a linear heating element.

In an embodiment of any of the above, the at least a portion of an electrically conductive path between the first type of electrical contact and the second type of electrical contact extends across a length of the aerosol generating material. In an embodiment of any of the above, the at least a portion of an electrically conductive path between the first type of electrical contact and the second type of electrical contact extends across a length of the aerosol generating layer.

In an embodiment of any of the above, each resistive heating element is crenelated.

In an embodiment of any of the above, the resistive heating layer is a single resistive heating sheet comprising the plurality of resistive heating elements.

According to an aspect, there is provided an article comprising an aerosol generator of any embodiment described above.

According to an aspect, there is provided an aerosol provision device configured to receive an aerosol generator of any of any embodiment described above.

According to an aspect, there is provided an aerosol provision device comprising an article of any embodiment described above.

According to an aspect, there is provided an aerosol provision system comprising an aerosol generator of any embodiment described above or an article of any embodiment described above, and an aerosol provision device configured to receive one of the article and aerosol generator.

According to an aspect, there is provided an aerosol generator of any embodiment described above, an article of any embodiment described above, an aerosol provision device of any embodiment described above, or an aerosol provision system of any embodiment described above, comprising a control circuit.

In an embodiment of any of the above, wherein the control circuit is configured to generate the control signal.

In an embodiment of any of the above, wherein the control circuit is configured to interrogate the or at least one of each resistive heating element to determine whether the respective resistive heating element is inoperable.

In an embodiment of any of the above, wherein the control circuit is configured to produce a control signal for a selected heating element of an aerosol generator, wherein, in a first mode of operation, the control signal has a voltage in excess of a breakdown voltage of the heating element, such that the heating element is rendered inoperable in response to the control signal.

In an embodiment of any of the above, wherein in a second mode of operation, the control signal has a voltage below said breakdown voltage such that the heating element is heated in order to heat a portion of the aerosol generating material to generate an aerosol.

According to an aspect, there is provided a blank for forming an aerosol generator of an article for an aerosol provision device, the blank comprising: an aerosol generating layer comprising an aerosol generating material; and a resistive heating layer comprising a resistive heating element, the resistive heating element being configured to heat at least a portion of aerosol generating material; wherein the resistive heating element comprises an electrical contact of a first type and an electrical contact of a second type, and the resistive heating element extends between the electrical contact of the first type and the electrical contact of the second type; and wherein the resistive heating element has a breakdown voltage, such that the resistive heating element is rendered inoperable in response to a control signal in excess of the breakdown voltage.

In an embodiment of any of the above, the blank comprises aerosol generating material. In an embodiment of any of the above, the blank comprises an aerosol generating layer comprising the aerosol generating material. In an embodiment of any of the above, the aerosol generating layer is on the resistive heating layer.

According to an aspect, there is provided a method comprising: providing an aerosol generator comprising a resistive heating layer comprising a resistive heating element, the resistive heating element providing an electrically conductive path for resistive heating of a portion of an aerosol generating material to generate an aerosol, wherein the resistive heating element comprises an electrical contact of a first type to an electrical contact of a second type, and extends from the electrical contact of the first type to the electrical contact of the second type; and aerosol generating material on the resistive heating layer; and applying a control signal to the resistive heating element, wherein the control signal has a voltage in excess of a breakdown voltage of the resistive heating element, such that the resistive heating element is rendered inoperable in response to the control signal.

In an embodiment of any of the above, the aerosol generating material is in contact with an aerosol generating layer.

According to an aspect, there is provided an aerosol generator of an article for an aerosol provision device, the aerosol generator comprising: aerosol generating material; and a resistive heating layer comprising a resistive heating element, the resistive heating element being configured to heat at least a portion of aerosol generating material; wherein the resistive heating element comprises an electrical contact of a first type and an electrical contact of a second type, and the resistive heating element extends between the electrical contact of the first type and the electrical contact of the second type.

In an embodiment of any of the above, the aerosol generator comprises an aerosol generating layer including the aerosol generating material. In an embodiment of any of the above, the aerosol generating layer is on the resistive heating layer.

According to an aspect, there is provided an aerosol generator comprising: an aerosolisable layer incorporating an aerosolisable material; and an electrically conductive layer in contact with said aerosolisable layer, wherein said electrically conductive layer is formed into a plurality of heating elements, each heating element providing an electrically conductive path for resistive heating of a portion of said aerosolisable material to generate an aerosol. Each heating element extends from an electrical connection of a first type to an electrical connection of a second type.

Furthermore, each heating element has a breakdown voltage, such that the respective heating element is rendered inoperable in response to a control signal in excess of the breakdown voltage. The aerosolisable layer may comprise a film or a gel incorporating said aerosolisable material.

In an embodiment of any of the above, in use, the control signal may be generated following usage of the respective heating element.

In an embodiment of any of the above, the aerosol generator may comprise a control circuit. In an embodiment of any of the above, the control circuit may be configured to generate said control signal. Alternatively, or in addition, in an embodiment of any of the above, the control circuit may be configured to interrogate one or more of said heating elements to determine whether a respective heating element is inoperable.

In an embodiment of any of the above, the aerosol generator may comprise an input for receiving said control signal. For example, a control circuit may be provided that is separate to the aerosol generator.

In an embodiment of any of the above, the electrical connections may enable the electric current to be individually provided to each of the plurality of heating elements. In an embodiment of any of the above, the aerosol generator may comprise a plurality of electrical connections of the first type (e.g. a plurality of positive electrical connections). In an embodiment of any of the above, each of said heating elements may, for example, have a separate electrical connection of the first type.

In an embodiment of any of the above, the electrical connections may comprise a single connection of a second type (e.g. a single negative electrical connection). In alternative embodiments of any of the above, separate connections of the first and second type are provided for each heating zone instead of using a common connection of the second type.

In an embodiment of any of the above, electrical connections of the first type are arranged on a first edge of the electrically conductive layer and electrical connections of the second type are arranged on a second edge of the electrically conductive layer.

However, other configurations are possible. In an embodiment of any of the above, electrical connections of the first and second type may be provided on opposite sides of an area in which the heating elements are provided. In an embodiment of any of the above, some or all of the electrical connections of the first and second type are provided on the same edge of the electrically conductive layer or the second side of the area in which the heating elements are provided.

In an embodiment of any of the above, the heating elements may be formed by cutting said electrically conductive layer (e.g. using a laser cutter). Alternatively, or in addition, the heating elements may be formed by one or more of: chemically etching said electrically conductive layer; forming or pressing the electrically conductive layer in a/the substrate; and printing said electrically conductive layer.

In an embodiment of any of the above, each heating element comprises a non-straight electrically conducting path (e.g. a meandering or serpentine path) between the first and second electrical connections.

In an embodiment of any of the above, each heating element is a linear heating element comprising a conducting path extending across a length of the aerosolisable layer.

In an embodiment of any of the above, the electrically conductive layer may be in the form of a foil. In an embodiment of any of the above, the electrically conductive layer may be a metal layer (e.g. a metal foil, such as an aluminium foil).

According to an aspect, there is provided a method comprising: forming an electrically conductive layer into a plurality of heating elements, each heating element providing an electrically conductive path for resistive heating of a portion of an aerosolisable material to generate an aerosol, wherein each heating element extends from an electrical connection of a first type to an electrical connection of a second type; placing the formed electrically conductive layer in contact with an aerosolisable layer, wherein said aerosolisable layer incorporates said aerosolisable material; and applying a control signal to a selected heating element, wherein the control signal has a voltage in excess of a breakdown voltage of said heating element, such that the respective heating element is rendered inoperable in response to said control signal.

In an embodiment of any of the above, the aerosolisable layer may comprise a film or a gel incorporating said aerosolisable material.

In an embodiment of any of the above, the control signal may be generated following usage of the respective heating element.

In an embodiment of any of the above, the method may further comprise interrogating one or more of said heating elements to determine whether a respective heating element is inoperable.

In an embodiment of any of the above, the method may further comprise receiving said control signal at an input.

In an embodiment of any of the above, the electrical connections may enable the electric current to be individually provided to each of the plurality of heating elements. In an embodiment of any of the above, the method may further comprise forming said heating elements, at least in part, by cutting said electrically conductive layer (e.g. using a laser cutter).

In an embodiment of any of the above, the method may further comprise forming said heating elements, at least in part, by chemically etching said electrically conductive layer.

In an embodiment of any of the above, the method may further comprise forming said heating elements, at last in part, by printing said electrically conductive layer.

In an embodiment of any of the above, each heating element comprises a non-straight electrically conducting path (e.g. a meandering or serpentine path) between the first and second electrical connections.

According to an aspect, there is provided a non-combustible aerosol generating device configured to receive an aerosol generator, article or consumable as set out above with reference to any of the embodiments mentioned above or formed in accordance with the method of any of the embodiments mentioned above.

According to an aspect, there is provided an apparatus configured to produce a control signal for a selected heating element of an aerosol generator, wherein, in a first mode of operation, the control signal has a voltage in excess of a breakdown voltage of said heating element, such that the respective heating element is rendered inoperable in response to said control signal.

In an embodiment of any of the above, the aerosol generator may be as set out above with reference to any of the embodiments mentioned above or formed in accordance with the method of any of the embodiments mentioned above. In an embodiment of any of the above, in a second mode of operation, the control signal may have a voltage below said breakdown voltage such that the selected heating element is heated in order to heat a portion of an aerosolisable material of the aerosol generator to generate an aerosol. In an embodiment of any of the above, apparatus may comprise a control circuit (for generating the control signal). In an embodiment of any of the above, apparatus may receive the control signal (e.g. from an external control circuit).

According to an aspect, there is provided a method comprising generating a control signal for a selected heating element of an aerosol generator, wherein, in a first mode of operation, the control signal has a voltage in excess of a breakdown voltage of said heating element, such that the respective heating element is rendered inoperable in response to said control signal. In an embodiment of any of the above, in a second mode of operation, the control signal may have a voltage below said breakdown voltage such that the selected heating element is heated in order to heat a portion of an aerosolisable material of the aerosol generator to generate an aerosol.

According to an aspect, there is provided a system comprising: a non-combustible aerosol generating device of any of the embodiments mentioned above and an aerosol generator, article or consumable as set out above with reference to any of the embodiments mentioned above or formed in accordance with the method of any of the embodiments mentioned above. The aerosol generator, article or consumable may further comprise an apparatus as set out with reference to any of the embodiments mentioned above.

According to an aspect, there is provided a kit of parts comprising: a non-combustible aerosol generating device of any of the embodiments mentioned above and an aerosol generator, article or consumable as set out above with reference to any of the embodiments mentioned above or formed in accordance with the method of any of the embodiments mentioned above, wherein said aerosol generator is detachable from said non-combustible aerosol generating device. The kit of parts may further comprise an apparatus as set out with reference to any of the embodiments mentioned above. The non-combustible aerosol generating device may comprise an integrated battery.

### BRIEF DESCRIPTION OF THE DRAWINGS

Example embodiments will now be described, by way of example only, with reference to the following schematic drawings, in which:

FIG. 1 is a block diagram of an aerosol provision system;

FIG. 2 is a block diagram of an aerosol generator of the system of FIG. 1;

FIG. 3 is a block diagram of an aerosol generator;

FIG. 4 shows a heating element;

FIG. 5 shows an electrically conductive layer;

FIG. 6 is a flow chart showing an algorithm;

FIG. 7 is a flow chart showing an algorithm;

FIG. 8 shows an aerosol generator being formed;

FIG. 9 is a block diagram of an aerosol generator ;

FIG. 10 is a block diagram of a system;

FIG. 11 is a flow chart showing an algorithm;

FIG. 12 shows an electrically conductive layer;

FIG. 13 is a flow chart showing an algorithm;

FIG. 14 is a flow chart showing an algorithm;

FIG. 15 shows an electrically conductive layer;

FIG. 16 shows an electrically conductive layer;

FIG. 17 shows part of an aerosol generator;

FIG. 18 shows a connector;

FIG. 19 is a block diagram of an aerosol provision system; and

FIGS. 20 and 21 show heating elements.

### DETAILED DESCRIPTION

As used herein, the term “delivery mechanism” is intended to encompass systems that deliver a substance to a user, and includes:
non-combustible aerosol provision systems that release compounds from an aerosolisable material without combusting the aerosolisable material, such as electronic cigarettes, tobacco heating products, and hybrid systems to generate aerosol using a combination of aerosolisable materials; and
articles comprising aerosolisable material and configured to be used in one of these non-combustible aerosol provision systems.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance (sometimes referred to herein as an active compound).

The active substance as used herein may be a physiologically active material, which is a material intended to achieve or enhance a physiological response. The active substance may for example be selected from nutraceuticals, nootropics, psychoactives, or digiceutical or other technical/electronic devices that may induce a physiological response, such as vagus nerve stimulation (VGS). The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In one embodiment, the active substance is a legally permissible recreational drug.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c. v, Mentha spicata crispa, Mentha cardifolia, Memtha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco. In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavour.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosolisable material, which also may be referred to herein as aerosol generating material, is material that is capable of generating aerosol, for example when heated, irradiated or energized in any other way. Aerosolisable material may, for example, be in the form of a solid, liquid or gel which may or may not contain nicotine and/or flavourants.

Aerosol-generating material (which is sometimes referred to herein as an aerosolisable material) is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

The slurry may be heated to remove at least about 60 wt %, 70 wt %, 80 wt %, 85 wt % or 90 wt % of the solvent.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

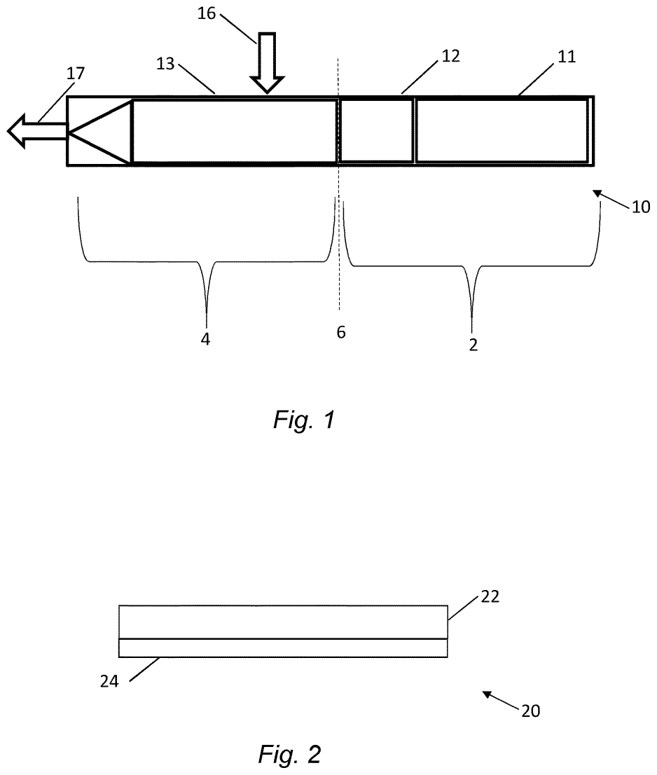

FIG. 1 is a block diagram of an aerosol generating device, indicated generally by the reference numeral 10, in accordance with an example embodiment.

The aerosol generating device 10 comprises a battery 11 (e.g. a rechargeable battery), a control circuit 12, and an aerosol generator 13. As discussed in detail below, the aerosol generator 13 comprises a resistive heater for heating an aerosolisable material (e.g. a film or a gel) to generate an aerosol (e.g. a vapour). The aerosolisable material is sometimes referred to an as aerosol generating material.

The resistive heater comprises at least one resistive heating element. The battery 11 acts a power source. The control circuit acts as a controller, and comprises a processor and a memory. The control circuit is configured to implement the or each method set out below.

In the use of the device 10, air is drawn into an air inlet of the aerosol generator 13, as indicated by arrow 16. An aerosol generated by the aerosol generator 13 exits the device at an air outlet, as indicated by arrow 17 (for example into the mouth of a user of the device 10).

In some example embodiments, the aerosol generating device 10 comprises two main components, namely a control section 2 (which may be referred to as a reusable part) and a consumable part 4 (which may be referred to as a replaceable or disposable cartridge). In the use of the aerosol generating device 10, the control section 2 and the consumable part 4 may be releasably connected at an interface 6. The consumable part 4 may be removable and replaceable (e.g. when the consumable part is used), with the control section 2 being re-used with a different consumable part.

The aerosol generating device 10 including the aerosol generator 13 can be considered as together forming an aerosol provision system comprising the control section 2, which may also be referred to as the aerosol provision device, and the consumable part 4, which may also be referred to as the article 4. The aerosol generating device 10 may also be referred to herein as the aerosol provision system.

The aerosol generator 13 forms part of the article 4. The aerosol generator 13 comprises a resistive heating arrangement configured to heat aerosol generating material, for example at least one of a film or and a gel to generate an aerosol.

The or each heating element in embodiments is a resistive heating element, as described in detail below. In such arrangements the system comprises a resistive heating generator including components to heat the heating arrangement via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. The provision of a resistive heating arrangement allows for a compact arrangement. Resistive heating provides a space-efficient configuration.

A ‘section’ may be referred to as a ‘part’. A ‘part’ may be referred to as a ‘section’. A consumable part may be referred to as a replaceable or disposable article.

Of course, the aerosol generating device 10 is provided by way of example only and is highly schematic. Many alternative aerosol generating devices and other devices may be used in example implementations of the principles described here. For example, in some example embodiments, air is drawn into an air inlet in the control section 2, passes through the interface 6, and exits the consumable part 4.

The aerosol generator 13 is configured to generate an aerosol from the aerosol generating material, also known as aerosolisable material, upon operation of the aerosol provision system, as will be described in detail below. The aerosol provision system 10 is elongate, extending along a longitudinal axis. The aerosol provision system 10 has a proximal end, which will be closest to the user (e.g. the user's mouth) when in use by the user to inhale the aerosol generated by the aerosol provision system 10, and a distal end which will be furthest from the user when in use. The proximal end may also be referred to as the “mouth end”. The aerosol provision system 10 accordingly defines a proximal direction, which is directed towards the user when in use. Further, the aerosol provision system 10 likewise defines a distal direction, which is directed away from the user when in use. The terms ‘proximal’ and ‘distal’ as applied to features of the system 10 will be described by reference to the relative positioning of such features with respect to each other in a proximal-distal direction along a longitudinal axis.

In embodiments, the aerosol generator 13 may be fully or partially inserted into the aerosol provision device 10. The configuration of the aerosol provision device 10 may vary, for example an opening may be in a longitudinal side wall of the aerosol provision device 10, and/or may be closed by another feature of the aerosol provision device 10 during use. In the present configuration, the article 4 defines a mouthpiece at the proximal end. In embodiments, the aerosol provision device 10 defines the mouthpiece. The user places their mouth over the mouthpiece during use.

FIG. 2 is a block diagram of an aerosol generator, indicated generally by the reference numeral 20, in accordance with an example embodiment. The aerosol generator 20 is an example implementation of the aerosol generator 13 of the aerosol generating device 10 described above.

The aerosol generator 20 comprises an aerosolisable layer 22 (incorporating an aerosolisable material) and an electrically conductive layer 24 in contact with said aerosolisable layer. As described in detail below, the electrically conductive layer 24 is formed into one or more heating elements, each heating element providing an electrically conductive path for resistive heating of a portion of the aerosolisable material of the aerosolisable layer 22 to generate an aerosol. The aerosolisable material may, for example, be in the form of a film or a gel. The electrically conductive layer is also referred to as the resistive heating layer.

The aerosolisable layer 22, also referred to as an aerosol generating layer 22, comprises the aerosolisable material, also known as aerosol generating material.

The electrically conductive layer 24 is formed as a resistive heating layer. The resistive heating layer comprises material capable of being resistively heated in response to an electrical current being passed through the material.

The aerosol generator 20 comprises the resistive heating layer 24. The aerosol generating layer 22 is on the resistive heating layer 24. The aerosol generating layer 22 is in direct contact with the resistive heating layer 24. In embodiments, the aerosol generating layer 22 is in indirect contact with the resistive heating layer 24. The resistive heating layer 24 may in embodiments comprise a coating. The coating of the resistive heating layer 24 may be on the electrically conductive material.

The electrically conductive layer 24 may take the form of a metal layer, such as an aluminium layer or a non-metallic material (such as graphene). The electrically conductive layer may be in the form of a foil (e.g. an aluminium foil).

The aerosol generator 20 is configured to generate an aerosol from the aerosol generating material upon operation of the aerosol provision system 10, as will be described in detail below.

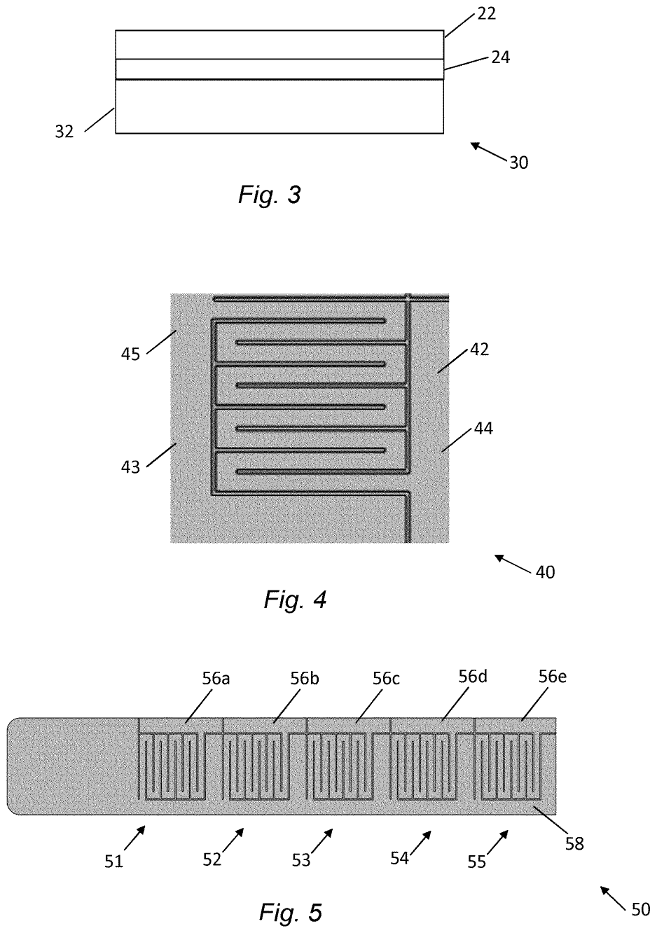

FIG. 3 is a block diagram of an aerosol generator, indicating generally by the reference numeral 30, in accordance with an example embodiment. The aerosol generator 30 is an example implementation of the aerosol generator 13 described above.

The aerosol generator 30 comprises the aerosolisable layer 22 and the electrically conductive layer 24 described above. The aerosol generator 30 further comprises a support (or substrate) 32. The support 32 may comprise a paper or card material that provides structural support for the aerosol generator 30. As shown in FIG. 3, in the aerosol generator 30, the electrically conductive layer 24 is sandwiched between the support 32 and the aerosolisable layer 22.

In embodiments, the electrically conductive layer, also referred to as the resistive heating layer 24, is on the support 32. The support 32 is configured as a support layer. The support 32 is electrically insulative. The resistive heating layer 24 and the support layer 32 define the substrate. The substrate 32 supports the aerosol generating layer

In embodiments, the aerosol generator 30 comprises a laminate comprising the resistive heating layer 24 and the support layer 32. In embodiments, the laminate comprises the aerosol generating layer 22. The aerosol generating layer 22 may be formed as a contiguous configuration, or may be formed from discrete portions. The discrete portions may comprise one or more of dots, strips, spirals, or other shapes. In embodiments, the discrete portions align with the resistive heating elements.

One or more of the aerosol generating layer 22, resistive heating layer 24 and the support layer 32 may comprise a further layer. For example, the support layer 32 may comprise a backing layer or an intermediate layer. The support layer 32 in embodiments is omitted.

The or each aerosol generator 30 are formed in a stacked configuration. In embodiments, other arrangements such as a tubular arrangement of the article are envisaged. In such tubular arrangements the aerosol generator 30 defines a tubular configuration. Tubular may include circular or elliptical cross-sectional and other polygonal shapes.

In embodiments, as shown in the Figures, the article 30 has a flat configuration. That is, wherein an exterior of the article has a length, a width perpendicular to the length, and a depth perpendicular to each of the length and the width, wherein the length is greater than or equal to the width, and wherein the width is greater than the depth. Other configurations are envisaged.

FIG. 4 shows a heating element, indicated generally by the reference numeral 40, in accordance with an example embodiment. One or more heating elements 40 may be formed by the electrically conductive layer 24 described above.

The heating element 40 comprises a non-straight electrically conducting path between a first electrical connection 42 and a second electrical connector 43. In some example embodiments, the first electrical connection 42 provides a positive connection and the second electrical connection 43 provides a negative connection such that electrical current flows between the electrical connections through the path. The meandering or serpentine nature of the path of the heating element 40 increases the total length of the path between the first and second electrical connectors, such that the electrical resistance of the path is increased (when compared with a straight, direct, path between the first and second electrical connectors).

The electrically conductive path defines a resistive heating path. The resistive heating path is formed by the electrically conducting path. The resistive heating path is non-Attorney straight. The resistive heating path is convoluted. The configuration of the resistive heating path may vary. The electrical resistance of the heating element 40 may be dependent on the nature of the resistive heating path in the conductive layer, for example the length, width, thickness and arrangement of the path. The electrical resistance of the resistive heating path may also be dependent on the material from which the resistive heating path is formed.

The first and second electrical connections may be referred to as a first type of electrical contact 42 (or an electrical contact of a first type) and a second type of electrical contact 43 (or an electrical contact of a second type) respectively. The contact arrangement may be reversed. The first and second types of electrical contacts define heater electrical contacts. The first and second types of electrical contacts 42, 43 form at least part of an article electrical contact configuration.

As discussed in detail below, the conducting path of the heating element 40 may be created by forming tracks in the heating element, for example by cutting the tracks into an electrically conducting layer that makes up the heating element. In some example embodiments, the tracks may have a width in the region of 0.5 mm to 1 mm (two example prototypes have widths of 0.93 mm and 0.72 mm respectively) and gaps between the tracks of less than about 0.25 mm (the same two example prototypes have gaps of 0.2 mm and 0.05 mm respectively). The heating element may have overall dimensions of the order of 10 mm x 10 mm. Of course, other dimensions are possible in other example embodiments. By forming the heating element of these dimensions from an aluminium foil of having a thickness of 0.006 mm and an electrical resistivity of between 2 and 6 μOhmcm, the resistance of the path has been calculated to be of the order of 1 Ohm. In one example embodiment, the resistance was measured at between 0.83 and 1.31 Ohms.

The resistive heating layer comprises a plurality of resistive heating elements 40. The plurality of heating elements 40 are formed in an array as shown in FIG. 5. The array of heating elements may be arranged in a single row. The array of heating elements may be arranged in a single row along a longitudinal axis of the aerosol generator. The array of heating elements may be arranged in a single row transverse a longitudinal axis of the aerosol generator. Other configurations are envisaged.

The resistive heating element 40 comprises a first type of electrical track 44. The first type of electrical track 44 comprises the first type of electrical contact 42. The electrical contact 42 of the first type is configured to electrically connect with the device electrical connector. The first type of electrical contact 42 comprises a first type of exposed contact region. The first type of exposed contact region is exposed on the article for direct connection with the device electrical connector.

The resistive heating element 40 comprises a second type of electrical track 45. The second type of electrical track 45 comprises the second type of electrical contact 43.

The electrical contact 43 of the second type is configured to electrically connect with the device electrical connector. The second type of electrical contact 43 comprises a second type of exposed contact region. The second type of exposed contact region is exposed on the article for direct connection with the device electrical connector.

The conducting path of the heating element in embodiments is created by defining at least one electrically insulative barrier in the resistive heating layer 24. In embodiments, the electrically insulative barrier is formed by cutting electrically conductive restrictions (i.e. electrically insulating portions), such as gaps, channels or slots into a sheet formed of electrically conductive material to form the resistive heating layer 24. In embodiments, the resistive heating layer 24 is preformed to define the or each resistive heating element 40 and then applied to the support 32. In embodiments, the resistive heating layer 24 is applied to the support 32, and the or each resistive heating element 40 then defined in the resistive heating layer 24. The or each restive heating element 40 defining the resistive heating layer 24 may be a printed heater. The at least one electrically insulative barrier defines the first and second types of electrical track. The electrically insulative barrier defines a barrier to electrical conduction across the barrier. The insulative barrier may be an air gap. In embodiments, the insulative barrier is a filled gap, for example filled with an insulative material. The barrier defines a barrier to electrical conduction across the barrier.

The or each resistive heating element 342 defining the resistive heating layer 340 may be formed by a cutting action. Cutting may include die cutting. The resistive heating element may be formed by an action applied to the resistive heating layer only. In embodiments, the resistive heating element may be formed by an action applied to the resistive heating layer and the support layer, for example an action of cutting the resistive heating layer and the support layer.

FIG. 5 shows an electrically conductive layer, indicated generally by the reference numeral 50, in accordance with an example embodiment. The electrically conductive layer 50 is an example implementation of the heating element 24 of the aerosol generator 20 or 30 described above.

The electrically conductive layer 50 is formed into a plurality of heating elements, indicated generally by the reference numerals 51 to 55. Each of the heating elements 51 to 55 extends from an electrical connection of a first type (the connections 56a to 56e respectively) to an electrical connection of a second type (the connection 58).

The number of electrical connections, which may also be referred to as electrical contacts, may vary. As such, each resistive heating element 51 to 55 extends between a discrete first type of electrical contact 56a to 56e and a common second type of electrical contact 58.

When the layer 50 is used as the heating element 24 of the aerosol generator 20 or 30, each of the heating elements 51 to 55 provides an electrically conductive path for resistive heating of a portion of the aerosolisable material of the support 22 to generate an aerosol at the respective portion of the support.

The separate electrical connections of the first type 56a to 56e enable an electric current to be individually provided to each of the plurality of heating elements 51 to 55. Thus, the heating of different zones of an aerosolisable material can be controlled. For example, an aerosol generator may be provided with five aerosol generating zones.

The layer 50 allows each of those zones to be activated separately. Thus, for example, five puffs of aerosol may be generated from a single consumable incorporating the heating elements 51 to 55.

Accordingly, for example, five puffs of aerosol may be generated from a single consumable incorporating a single aerosol generator 20 or 30, and ten puffs of aerosol may be generated from a single consumable incorporating two aerosol generators 20 or 30.

In the example electrically conducting layer 50, a plurality of electrical connections 56a to 56e of the first type (e.g. a positive electrical connection) are provided and a single connection of the second type 58 (e.g. a negative electrical connection) is provided.

This is not essential to all implementations. For example, multiple connections of the second type could be provided.

In embodiments each resistive heating element 51 to 55 comprises a corresponding one of the first type of electrical contact 42 and a corresponding one of the second type of electrical contact 43.

In the example electrically conducting layer 50, the electrical connections of the first type are arranged on a first edge of the electrically conductive layer and electrical connections of the second type are arranged on a second edge of the electrically conductive layer. This may allow for convenient connection of electrical power, but, of course, many other configurations are possible, some of which are discussed further below.

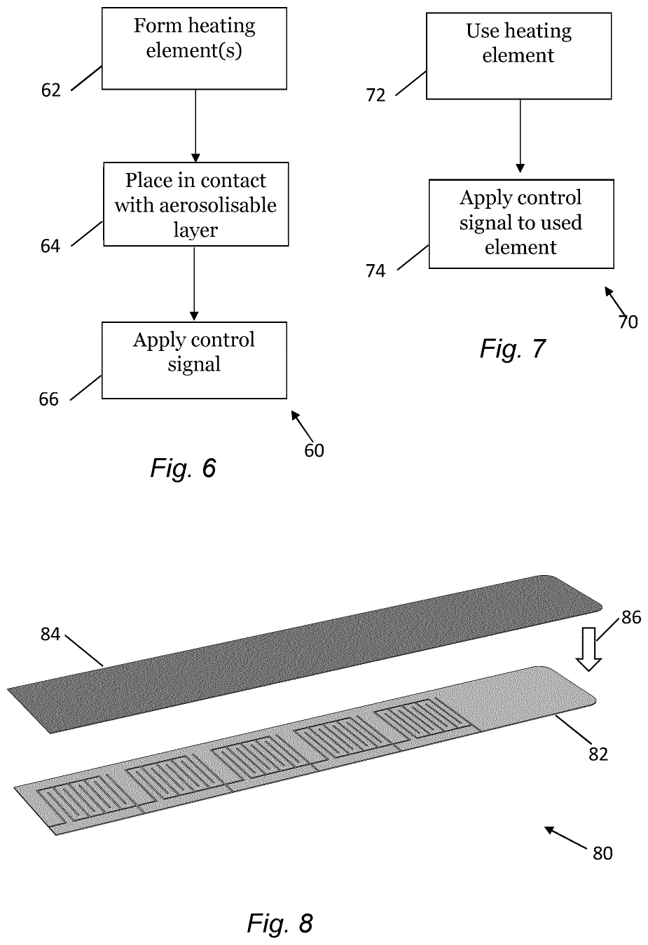

FIG. 6 is a flow chart showing an algorithm, indicated generally by the reference numeral 60, in accordance with an example embodiment. The algorithm 60 may be used to produce the aerosol generator 20 described above (for example incorporating the electrically conducting layer 50).

The algorithm 60 starts at operation 62, where an electrically conductive layer is formed into one or more heating elements (e.g. a plurality of heating elements), wherein each heating element extends from an electrical connection of a first type to an electrical connection of a second type. In use, the or each heating element may be used to provide an electrically conductive path for resistive heating of a portion of an aerosolisable material to generate an aerosol.

The formation of the or each resistive heating element may occur prior to or post application of the resistive heating layer on a support, where a support is present. The resistive heating layer may be adhered to the support, or mounted or formed on the support in a different configuration.

At operation 64, the formed electrically conductive layer is placed in contact with an aerosolisable layer, wherein said aerosolisable layer incorporates said aerosolisable material.

Said another way, at operation 64, at least one of the formed resistive heating layer and the aerosol generating layer is placed in contact with other component, wherein said aerosol generating layer incorporates aerosol generating material. In addition, or alternatively, the aerosol generating layer is formed on the resistive heating layer.

At operation 66, a control signal is applied to a selected heating element (i.e. one of the heating elements formed in the operation 62). The control signal, in one embodiment, can be used to cause the selected heating element to generate heat (in order to generate an aerosol from an aerosolisable material, as discussed above). However, as discussed further below, the control signal applied in the operation 66 may, in some embodiments, have a voltage in excess of a breakdown voltage of said heating element, such that the respective heating element is rendered inoperable in response to said control signal. In this way, a heating element can be rendered inoperable after use. In some example embodiments, a portion of aerosolisable material may be usable only once; the algorithm 60 enables a heating element to rendered in operable after the respective portion of aerosolisable material has been used.

FIG. 7 is a flow chart showing an algorithm, indicated generally by the reference numeral 70, in accordance with an example embodiment.

The algorithm 70 starts at operation 72, where one of a plurality of heating elements of an aerosol generator (such as the aerosol generators 50 or 80 described herein) is used. Then, at operation 72, a control signal is applied to the heating element used in the operation 72. The control signal applied in the operation 74 has a voltage in excess of a breakdown voltage of the respective heating element, such that the respective heating element is rendered inoperable in response to said control signal. In this way, the used heating element is rendered inoperable. The operation 74 is therefore an example of the operation 66 described above.

FIG. 8 shows an aerosol generator, indicated generally by the reference numeral 80, being formed in accordance with an example embodiment. The aerosol generator 80 comprises an electrically conductive layer 82 and an aerosolisable layer 84 incorporating an aerosolisable material. The aerosolisable material may, for example, be formed on the layer 84 by depositing aerosolisable material, for example by spraying, painting, dispensing or in some other way.

The electrically conductive layer 82 is formed into a plurality of heating elements in an example implementation of the operation 62 of the algorithm 60 described above. The electrically conductive layer 82 may, for example, be the electrically conducting layer 50 described above. The electrically conductive layer 82 may therefore comprise a plurality of heating elements that each comprise a non-straight electrically conducting path between the first and second electrical connections.

The electrically conducting layer 82 and the aerosolisable layer 84 are placed in contact with one another (as indicated by the arrow 86), in an example implementation of the operation 64 of the algorithm 60.

Each heating element of the electrically conducting later 82 has a breakdown voltage, such that the respective heating element is rendered inoperable in response to a control signal in excess of the breakdown voltage. A control signal may be applied to one of the heating elements of the electrically conducting layer after that heating element has been used to generate an aerosol, thereby implementing the algorithm 70 described above (and an embodiment of the operation 66 of the algorithm 60).

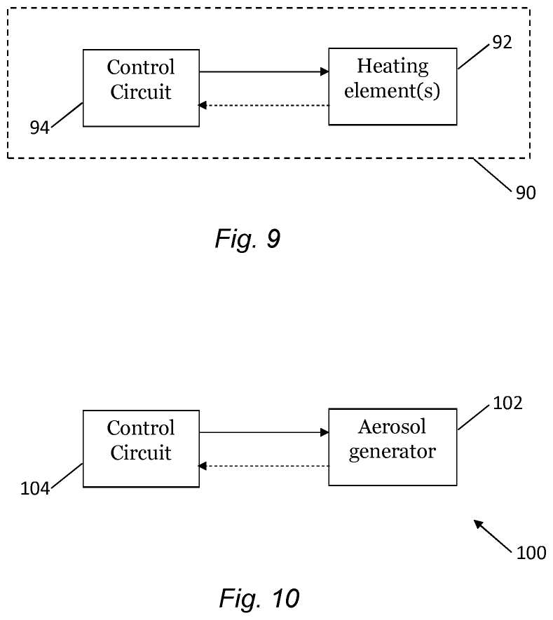

FIG. 9 is a block diagram of an aerosol generator 90 in accordance with an example embodiment. The aerosol generator 90 comprises one or more heating elements 92 (such as one or more of the heating elements described above) and a control circuit 94. The control circuit 94 may be used to generate the control signal applied to the heating element in the operations 66 or 74 described above. For example, the control signal may be generated by the control circuit 94 following usage of the respective heating element. In some example embodiments, the control circuit 94 may also generate a heating control signal in an implementation of the operation 72 of the algorithm 70.

In some example embodiments, the control circuit is able to interrogate the heating element(s) to determine whether a heating element is inoperable. This is indicated by the dotted arrow in FIG. 9.

FIG. 10 is a block diagram of a system, indicated generally by the reference numeral 100, in accordance with an example embodiment. The system 100 comprises an aerosol generator 102 (such as the aerosol generator 80 described above) and a control circuit 104. In common with the control circuit 94, the control circuit 104 may be used to generate a control signal applied to a heating element of the aerosol generator 102 in the operations 66 or 74 described above (and optionally in the operation 72 described above). Thus, the control signal may be generated following usage of the respective heating element. The system 100 differs from the aerosol generator 90 in that the control circuit 104 is provided separate to the aerosol generator 102.

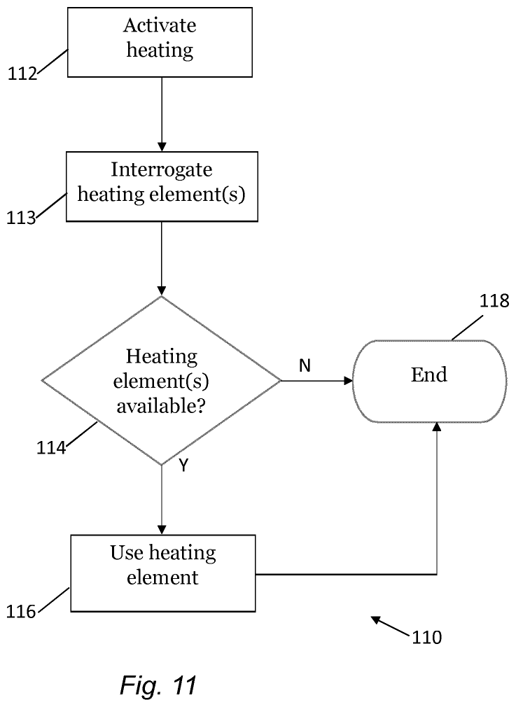

FIG. 11 is a flow chart showing an algorithm, indicated generally by the reference numeral 110, in accordance with an example embodiment. The algorithm 110 may, for example, be implemented using the aerosol generators 80 or 90, or the system 100, as described above.

The algorithm 110 is initiated when an instruction to activate heating is received in an instance of operation 112. In response to the instruction to activate heating, in operation 113, one or more heating elements (e.g. a target heating elements or any of a plurality of possible heating elements) are interrogated to determine whether the respective heating element is operatable or inoperable. For example, the operation 113 may be used to determine whether one or more respective heating elements have been rendered inoperable by the application of a suitable control signal.

At operation 114, a determination is made regarding whether a heating element is available. As discussed above, a plurality of heating elements may be provided. The operation 104 may involve determination which (if any) of the heating elements is operable; this may, for example, be an indication of which of the heating elements remain to be used (such that the corresponding available aerosolisable material has not yet been used).

If a heating element is available, the algorithm moves to operation 116, where an available heating element is used. As discussed above, heating elements may be individually controllable, for example by providing electrical power to individual heating elements. Once the operation 116 is complete, the algorithm terminates at operation 118.

If, at operation 114, a determination is made that no heating elements are available (e.g. because all heating elements have been used), or that a particular target heating element is not available, then the algorithm terminates at operation 118. This may mean that a consumable part being used to implement the algorithm 110 needs to be replaced.

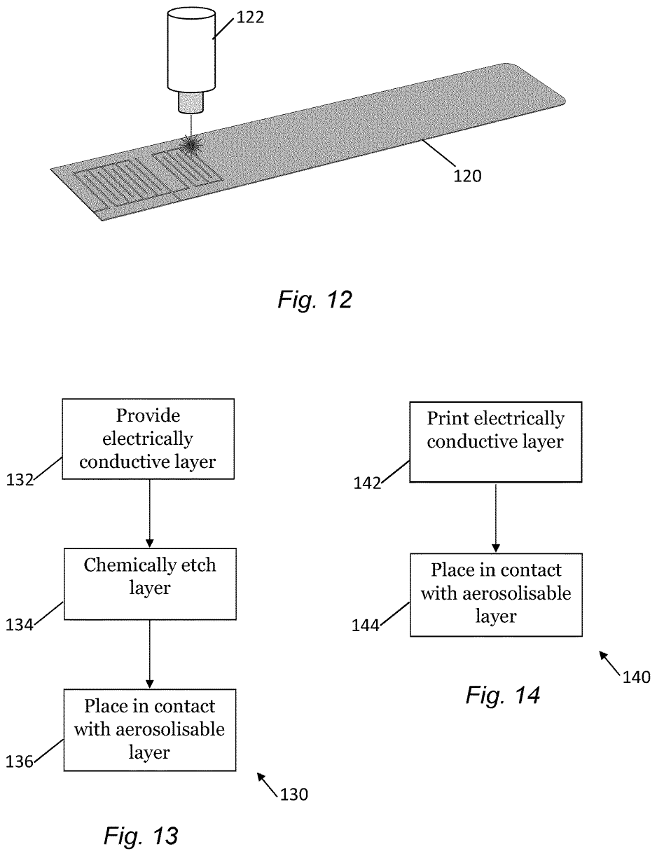

FIG. 12 shows an electrically conductive layer 120 being formed in accordance with an example embodiment. The electrically conductive layer 120 is being cut using a laser cutter 122. The cutting of the electrically conductive layer 120 can be used to form the paths of the heating elements described herein.

The use of the laser cutter 122 (or some other cutting process) is not the only method by which the electrically conductive layers described herein may be generated. Some example methods are described below.

FIG. 13 is a flow chart showing an algorithm, indicated generally by the reference numeral 130, in accordance with an example embodiment.

The algorithm 130 starts at operation 132, where an electrically conductive layer is provided. At operation 134, one or more heating elements are formed in the electrically conductive layer by chemically etching the electrically conductive layer. The operations 132 and 134 are an example implementation of the operation 62 of the algorithm 60 described above.

In operation 136 of the algorithm 130, the electrically conductive layer is placed in contact with an aerosolisable layer. The operation 136 is therefore an example of the operation 64 described above.

The flow chart of FIG. 13 may also be referred to as showing part of a method of forming an aerosol generator 20, 30, 80 or an algorithm. In embodiments, the method or algorithm 130 starts at operation 132, where the resistive heating layer is provided. At operation 134, one or more of the resistive heating elements are formed in the resistive heating layer by chemically etching the resistive heating layer. The operations 132 and 134 are an example implementation of the operation 62 of the method 60 described above. The aerosol generating material is then disposed on the resistive heating layer, thereby implementing the operation 64 described above.

FIG. 14 is a flow chart showing an algorithm, indicated generally by the reference numeral 140, in accordance with an example embodiment.

The algorithm 140 starts at operation 142, where heating elements are formed, at last in part, by printing an electrically conductive layer. The operation 142 is therefore an example implementation of the operation 62 of the algorithm 62 described above. In operation 144 of the algorithm 140, the electrically conductive layer is placed in contact with an aerosolisable layer. The operation 144 is therefore an example of the operation 64 described above.

The flow chart of FIG. 14 may also be referred to as showing part of a method of forming an aerosol generator 20, 30, 80 or an algorithm, indicated generally by the reference numeral 140. The method or algorithm 140 starts at operation 142, where one or more heating elements are formed, at last in part, by printing a resistive heating layer. The operation 142 is therefore an example implementation of the operation 62 of the algorithm 60 described above. The aerosol generating material is then disposed on the resistive heating layer, thereby implementing the operation 64 described above.

The cutting, etching and printing methods described above are provided by way of example; alternative methods are also possible. For example, a so-called “hot foiling” approach could be used in which a heating element is made out of an electrically conductive layer, and then assembled/bonded onto a substrate. Yet other techniques could be used, such as die cutting. Moreover, two or more technologies could be combined (e.g. electrical conductivity could be added to connection traces by adding more conductive material, such as additional foil, printed material, etc.). The skilled person will be aware of many further technologies, or combinations of technologies, that could be used in implementations of the principles described herein.

In the example embodiments described above, the heating element(s) comprises a non-straight electrically conducting path between a first electrical connection 42, 56 and a second electrical connector 43, 58 (e.g. a meandering path). This is not essential to all example embodiments. Some alternative configurations are described by way of example below.

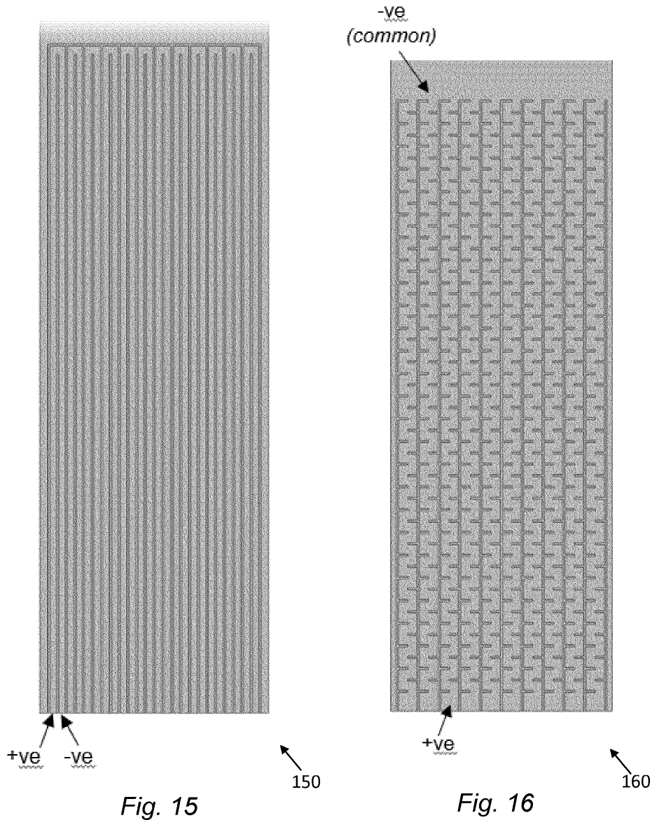

FIG. 15 shows an electrically conductive layer, indicated generally by the reference numeral 150, in accordance with an example embodiment. The electrically conductive layer 150 may be formed using the laser cutter 122 described above, or some similar device.

The electrically conductive layer 150 comprises a plurality of heating elements, each heater element being a linear heating element comprising a conducting path extending across a length of the support. Each heating element extends from an electrical connection of the first type (e.g. a positive electrical connection) to an electrical connection of the second type (e.g. a negative electrical connection). In the example layer 130, both types of electrical connection are provided at the same end of the layer and are provided next to each other. Thus, instead of a meandering path, the example path of the layer 130 extend from one end of the layer to the other and back again.

Note that there is no common second connection as is some other example embodiments; instead, each heating element has separate first and second electrical connections.

FIG. 16 shows an electrically conductive layer, indicated generally by the reference numeral 160, in accordance with an example embodiment. The electrically conductive layer 160 may be formed using the laser cutter 122 described above, or some similar device.

Said another way, the resistive heating layer 160 may be formed using the laser cutter 122 described above, or some similar device or another method. Each resistive heating element extends from one of the first type of electrical contact, for example a positive electrical contact, to the second type of electrical contact, for example a negative electrical contact.

The electrically conductive layer 160 comprises a plurality of heating elements, each heater element being a linear heating element comprising a conducting path extending across a length of the support. Each heating element extends from an electrical connection of the first type (e.g. a positive electrical connection) to an electrical connection of the second type (e.g. a negative electrical connection). In the example layer 140, the types of electrical connection are provided at the opposite ends of the layer and a common second (negative) connection is provided. Although a linear path is provided (rather than a meandering path), electrical resistance is provided by means of providing a crenelated path. Note that the paths of any other embodiments described herein could also be crenelated.

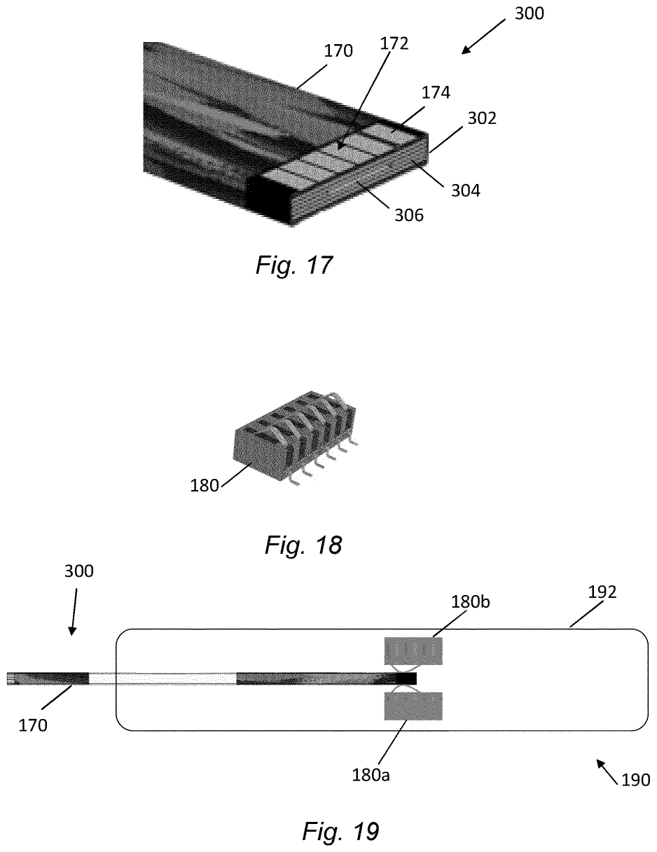

FIG. 17 shows part of an aerosol generator 170 in accordance with an example embodiment. As discussed above, the aerosol generator 170 may comprise an electrically conductive layer having plurality of electrical connections of a first type (e.g. providing positive electrical connections to each of a plurality of heating elements) and a single electrical connection of a second type (e.g. providing a common negative electrical connection to the plurality of heating elements). The aerosol generator 170 is part of an article 300.

Said another way, the article 300 has an article electrical contact configuration. The electrical contact configuration in embodiments is formed by the aerosol generator 170. The electrical contact configuration comprises heater electrical contacts 172, 174. The heater electrical contacts may also be known as heater or article contacts 172, 174.

The aerosol provision device comprises an electrical connector 180 as shown in FIG.

18. The electrical connector comprises connector electrical contacts. The connector electrical contacts may also be known as connector or device contacts. The article electrical contact configuration is configured to electrically communicate with the device electrical connector 180.

The first and second types of electrical contacts 42, 43, namely the heater contacts, together form at least part of the article electrical contact configuration of the aerosol generator 20, 30, 80.

The resistive heating elements 40 are on an inward side of the electrically conductive layer 82. The electrically conductive layer is a resistive heating layer. The inward side defines the first side of the aerosol generator 170. The heater contacts 42, 43 are on the second side of the resistive heating layer 82. The second side defines an outward side of the aerosol generator 170. The heater contacts are exposed so that they are able to be brought into contact with the device electrical connector. The heater contacts are on an opposing side of the resistive heating layer 82 to the resistive heating elements. Other configurations are envisaged.

The support layer 32 is between an inner portion of the resistive heating layer 82 and an outer portion of the resistive heating layer 82.

The aerosol generator 170 comprises a plurality of external connectors, the configuration of the external connectors being dependent on the configuration of the first and second type of electrical connections of the aerosol generator. For example, the aerosol generator as shown in FIG. 17 comprises a plurality of external connectors, indicated by the reference numeral 172 (each connected to one of the electrical connections of the first type) and a further external connector 174 (connected to the electrical connection of the second type). The aerosol generator 170 may have further external connectors corresponding to the connectors 172 and 174 on the underside of the device (not visible in FIG. 17).

FIG. 18 shows a connector 180 used in some example embodiments. The connector has separate pins for connection with electrical contacts, such as the connectors 172 and 174 described above.

The configuration of the article 300 may vary. The article 300 comprises a body 302.

The body 302 may be hollow. The body 302 may define a flow path through the article 300. The flow path extends between the air inlet and the aerosol outlet. The flow path is defined by an internal space in the article along which air and/or aerosol can flow.

The flow path is defined in the body 302. The or each aerosol generator 170 bounds the flow path. The aerosol generating material is exposed to the flow path. The aerosol generating material is exposed in the internal space. The internal space in embodiments comprises two or more chambers.

In FIG. 17, the distal end of the aerosol generator 170 and article 300 is shown. As shown, the body 302 comprises a plurality of body layers. The body layers are arranged in a stack of body layers 304. The body layers form a laminate. The body layers in embodiments are card layers. Other suitable materials may be used. The body layers 304 are configured to define features of the article 300. At least one body layer in embodiments comprises a gap defining an air inlet. The gap defines an opening 306.

The air inlet comprises the opening 306. The opening is formed in the body 302. In embodiments, the opening 306 is formed in another component of the article 300, for example the aerosol generator 170 or another wall feature. The aerosol outlet comprises an outlet opening. The outlet opening is formed in the body 302. In embodiments, the outlet opening is formed in another component of the article 300, for example the aerosol generator 170 or another wall feature.

In embodiments, the article 300 may comprise two aerosol generators 170 forming an aerosol generator arrangement. The number of aerosol generators 170 may differ.

Each aerosol generator 170 comprises aerosol generating material. The aerosol generating material is exposed to the flow path. In embodiments the article 300 comprises a single aerosol generator 170.

FIG. 19 is a block diagram of an aerosol generating device, indicated generally by the reference numeral 190, in accordance with an example embodiment. The system comprises the aerosol generator 170 described above, first and second connectors 180a and 180b (similar to the connector 180 described above) and a control section 192.

The aerosol generating device 190 is also known as aerosol provision system 190.

The control section 192 is similar to the control section 2 of the aerosol generating device 10 described above with reference to FIG. 1. The aerosol generator 170 is similar to the consumable part 4 of the aerosol generating device 10. The connectors 180a and 180b enable the control section 192 to provide regulated or controlled electrical voltages and/or currents to the various electrical connections of the first and second type of the aerosol generator 170 when the aerosol generator 170 is inserted into the control section 192 (as shown in FIG. 19). The control section 192 may, for example, implement the algorithm 110 described above.

In embodiments, the article 300 may be received by the aerosol provision device 190. The configuration of the article 300 and the aerosol provision device 190 may vary.

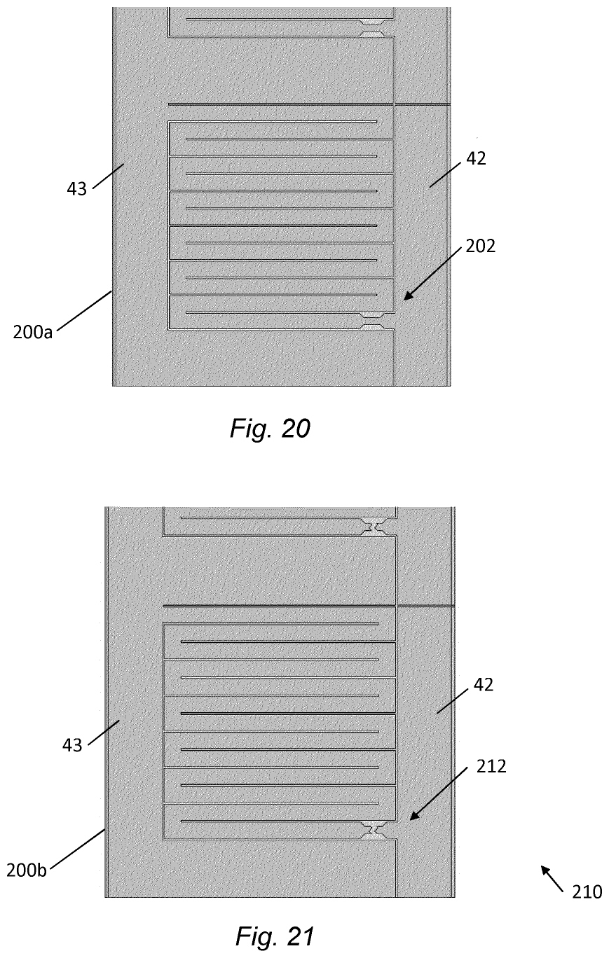

FIGS. 20 and 21 show a heating element 200 in accordance with an example embodiment. The heating element 200 may be formed by an electrically conductive layer (such as the layer 24 described above).

The heating element 200 comprises a plurality of non-straight electrically conducting path between a first electrical connection 42 and a second electrical connector 43 and is therefore similar to the heating element 40 described above. The heating element 200 differs from the heating element 40 in that a portion 202 of the electrically conducting path has been narrowed.

The heating element 200 can be used to implement the operation 66 of the algorithm 60 or the operation 74 of the algorithm 70 described above. FIG. 20 shows the heating element (denoted by 200a) before the operation 66 or 74. FIG. 21 shows the heating element (denoted by 200b) after the operation 66 or 74.

In the operations 66 and 74, a control signal is applied to the heating element 200. As discussed above, the control signal (e.g. in a first mode of operation) has a voltage in excess of a breakdown voltage of the heating element, such that the respective heating element is rendered inoperable in response to said control signal. FIG. 21 shows a portion 212 of the heating electrically conductive path having broken down (in the position of the narrowed portion 202 as shown in FIG. 20).

The provision of the narrowed portion 202 enables the location at which the heating element breaks down to be controlled. The extent to which the path is narrowed may also be used to control the breakdown in some way (e.g. to control a voltage and/or current level at which breakdown occurs).

The narrowed portion acts as a fuse portion. Another feature may be used instead of, or in combination with the narrowed portion 202 to act as a fuse portion. The fuse portion may comprise at least one hole, perforation, score mark or channel in the electrically conductive layer. The fuse portion may extend at least partially through the thickness of the electrically conductive layer. The fuse portion may extend fully though the thickness of the electrically conductive layer. The fuse portion may partially span the width of the path of the heating element. The fuse portion may comprise a portion of reduced width in the path of the heating element.

The fuse portion has a breakdown voltage which when the control signal having a voltage in excess of the breakdown voltage is applied, the fuse portion will break or rupture. Once the fuse portion has broken, the heating element 200 will be rendered in operable. The electrical connection between the heating element 200 and the first electrical connection 42 is broken on application of the control signal.

Each heating element 200 may have its own fuse portion. Each fuse portion of a heating element may have the same or different breakdown voltages.

In some embodiments of the different arrangements of aerosol generators and articles described above the aerosol generating material is formed in a configuration other than as an aerosol generating layer. The aerosol generating material in embodiments is in the form of an aerosol generating segment. The aerosol generating segment generally comprises a solid material. Such a solid material may be shredded tobacco. The aerosol generating material, arranged as an aerosol generating segment for example, may comprise a plurality of individual pieces of aerosol generating material. The aerosol generating material may be individual pieces of tobacco material. In embodiments, the aerosol generating material comprises a plurality of strips, beads or pellets. In embodiments the aerosol generating segment is a plug of material.

The aerosol generating segment in embodiments comprises a body of material. The aerosol generating material is a non-liquid. In such an embodiment, the body of material comprises a rod of aerosol generating material, for example a tobacco rod. For example, the body of material may comprise shredded tobacco material. The body of material may be formed into a rod. In some embodiments, the body of material comprises cut rag tobacco that is formed into a rod. The aerosol generating material may comprise tobacco material. The aerosol generating material may comprise extruded tobacco. The aerosol generating material may comprise reconstituted tobacco.

The aerosol generating material, formed as a solid material, may comprise nicotine. The aerosol generating material may comprises, consist of, or essentially consist of, tobacco. In embodiments, the aerosol generating material is free from tobacco.

In embodiments of any of the above, the heating of the article provides a relatively constant release of volatile compounds into an inhalable medium. In an embodiment of the above, the aerosol generating segment is a plug of material. The article may comprise a mouth end section. A tubular element may be located between the aerosol generating material and the mouth end section. The article may comprise a ventilation area in the mouth end section. The mouth end section may define a mouthpiece configured to be placed between a user's lips.

In embodiments of any of the above described articles, the or each resistive heating element is configured to heat substantially the entire aerosol generating material. The aerosol generating segment in embodiments is at least substantially cylindrical. In embodiments, the aerosol generating segment is at least partially wrapped by the resistive heating layer. In embodiments, the resistive heating element extends in the aerosol generating segment. The resistive heating element may extend around the aerosol generating segment. In embodiments, the resistive heating element encircles the aerosol generating segment. In some arrangements at least a portion of the flow path through the article is through the aerosol generating segment. The aerosol generating segment may define part of the air path. In embodiments, the first type of electrical contact and the second type of electrical contact are exposed from the aerosol generating segment.

The aerosol generating material may comprise tobacco material as described herein, which includes a tobacco component. In the tobacco material described herein, the tobacco component may contain paper reconstituted tobacco. The tobacco component may also contain leaf tobacco, extruded tobacco, and/or bandcast tobacco. The tobacco material may be provided in the form of cut rag tobacco. The cut rag tobacco can be formed from a mixture of forms of tobacco material, for instance a mixture of one or more of paper reconstituted tobacco, leaf tobacco, extruded tobacco and bandcast tobacco. In embodiments, the tobacco material comprises paper reconstituted tobacco or a mixture of paper reconstituted tobacco and leaf tobacco. In the tobacco material described herein, the tobacco material may contain a filler component. The filler component is generally a non-tobacco component, that is, a component that does not include ingredients originating from tobacco. The filler component may be a non-tobacco fibre such as wood fibre or pulp or wheat fibre. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent. In the tobacco material described herein, the tobacco material contains an aerosol-former material. In this context, an “aerosol-former material” is an agent that promotes the generation of an aerosol. An aerosol-former material may promote the generation of an aerosol by promoting an initial vaporisation and/or the condensation of a gas to an inhalable solid and/or liquid aerosol. In some embodiments, an aerosol-former material may improve the delivery of flavour from the aerosol generating material. In general, any suitable aerosol-former material or agents may be included in the aerosol generating material of the invention, including those described herein.

Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibres) by deposition of the extract onto the fibrous material. The process of recombination resembles the process for making paper.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol generator of an article for an aerosol provision device, the aerosol generator comprising:
aerosol generating material; and
a resistive heating layer comprising a resistive heating element, the resistive heating element being configured to heat at least a portion of the aerosol generating material, the aerosol generating material being on the resistive heating layer;
wherein the resistive heating element comprises an electrical contact of a first type and an electrical contact of a second type, and the resistive heating element extends between the electrical contact of the first type and the electrical contact of the second type; and
wherein the resistive heating element has a breakdown voltage, such that the resistive heating element is rendered inoperable in response to a control signal in excess of the breakdown voltage.

2. The aerosol generator of claim 1, wherein the resistive heating element is one of a plurality of resistive heating elements of the resistive heating layer.

3. The aerosol generator of claim 2, wherein each of the resistive heating elements has a breakdown voltage, such that the respective heating element is rendered inoperable in response to a control signal in excess of the breakdown voltage.

4. The aerosol generator of claim 2, wherein each resistive heating element is configured to heat a respective portion of the aerosol generating material.

5. The aerosol generator of claim 2 wherein said electrical contacts enable the electric current to be individually provided to each of the plurality of resistive heating elements.

6. The aerosol generator of claim 1, comprising an aerosol generating layer including the aerosol generating material.

7. The aerosol generator of claim 1 comprising an input for receiving the control signal.

8. The aerosol generator of claim 7, wherein, in use, the control signal is configured to be generated following usage of the heating element.

9. The aerosol generator of claim 1, wherein the resistive heating element comprises a fuse portion which has a breakdown voltage.

10. The aerosol generator of claim 1, wherein the fuse portion has a breakdown portion lower than a breakdown voltage of a remainder of the resistive heating element.

11. (canceled)

12. (canceled)

13. (canceled)

14. An aerosol provision system comprising:
the aerosol generator of claim 1; and
an aerosol provision device configured to receive the aerosol generator.

15. The aerosol provision system of claim 14, comprising a control circuit configured to generate the control signal.

16. The aerosol provision system of claim 15, wherein the control circuit is configured to interrogate the or at least one of each resistive heating element to determine whether the respective resistive heating element is inoperable.

17. The aerosol provision system of claim 15, wherein the control circuit is configured to produce a control signal for a selected heating element of an aerosol generator, wherein, in a first mode of operation, the control signal has a voltage in excess of a breakdown voltage of the heating element, such that the heating element is rendered inoperable in response to the control signal.

18. The aerosol provision system of claim 17, wherein in a second mode of operation, the control signal has a voltage below said breakdown voltage such that the heating element is heated in order to heat a portion of the aerosol generating material to generate an aerosol.

19. (canceled)

20. A method comprising:
providing an aerosol generator comprising a resistive heating layer comprising a resistive heating element, the resistive heating element providing an electrically conductive path for resistive heating of a portion of an aerosol generating material to generate an aerosol, wherein the resistive heating element comprises an electrical contact of a first type to an electrical contact of a second type, and extends from extends from the electrical contact of the first type to the electrical contact of the second type; and aerosol generating material on the resistive heating layer; and
applying a control signal to the resistive heating element, wherein the control signal has a voltage in excess of a breakdown voltage of the resistive heating element, such that the resistive heating element is rendered inoperable in response to the control signal.

21. (canceled)
